(19) United States
(12) Patent Application Publication
(10) Pub. No.: US 2003/0112916 A1
(43) Pub. Date: Jun. 19, 2003

(54) Cold nuclear fusion under non-equilibrium conditions

(76) Inventors: Franklin W. Keeney, (US); Steven E. Jones, (US); Alben C. Johnson, (US)

Correspondence Address: FINNEGAN, HENDERSON, FARABOW, GARRETT & DUNNER, LLP, 1300 I STREET, NW, WASHINGTON, DC, 20005, US

(21) Appl. No.: 09/514,202

(22) Filed: Feb. 25, 2000

(51) Int. Cl. G21J 1/00; G21B 1/00

(52) U.S. Cl. 376/100

(57) ABSTRACT

A method of producing cold nuclear fusion and a method of preparing a fusion-promoting material for producing cold nuclear fusion are disclosed. The method of producing fusion includes selecting a fusion-promoting material, hydriding the fusion-promoting material with a source of isotopic hydrogen, and establishing a non-equilibrium condition in the fusion-promoting material. The method of producing fusion may include cleaning the fusion-promoting material. The method of producing fusion may also include heat-treating the fusion-promoting material. The method of preparing a fusion-promoting material for producing fusion includes selecting a fusion-promoting material and hydriding the fusion-promoting material with a source of isotopic hydrogen. The method of preparing a fusion-promoting material for producing fusion may include cleaning the fusion-promoting material. The method of preparing a fusion-promoting material for producing fusion may also include heat-treating the fusion-promoting material.

### BACKGROUND OF THE INVENTION

1. Field of the Invention

The present invention relates to fusion energy. More particularly, the present invention relates to a method for producing cold nuclear fusion and a method for preparing a fusion-promoting material for producing cold nuclear fusion.

2. Description of the Related Art

Mankind employs many energy sources. Oil, coal, natural gas, water (hydroelectric), and nuclear fission number among the most prominent of these sources. However, most of these sources exists in a limited supply, produces a relatively small quantity of energy per unit of the given source, or raises environmental concerns. Thus, because earth's population and energy needs continue to climb dramatically, researchers continue to seek more plentiful, efficient, and environmentally-friendly energy sources.

These needs have led researchers to consider nuclear fusion, the process that powers the sun. First, the raw materials for nuclear fusion abound on our planet. For example, deuterium is plentiful in seawater. Second, fusion of atomic particles and/or light nuclei produces more energy for a given amount of material than virtually any other known energy source. Finally, nuclear fusion holds strong promise as an environmentally-safe process. For these reasons, and based on major technological advances in the latter half of the twentieth century, many knowledgeable individuals now anticipate that nuclear fusion may provide a long-term answer to mankind's energy needs.

Currently however, producing, controlling, and sustaining a fusion reaction proves highly elusive. Although billions of dollars have been invested in more than fifty years of research directed to commercial fusion energy production, at present these efforts fall far short of commercial energy applications. Researchers have directed most of this money and time in attempts at recreating the extreme conditions at thermonuclear temperature levels. These extreme conditions present enormous technological challenges which, in turn, demand extraordinary financial investments. Lack of success and financial difficulties have forced many skilled scientists and engineers to reduce or abandon such research.

Some investigators have studied alternative methods for producing fusion. The most publicized of these studies involved an electrochemical cell which included what is termed “heavy water,” deuterium oxide (D₂O). Electrochemical-cell investigators claimed cells of this type produced excess heat, demonstrating cold fusion occurred in such cells. Numerous scientists worldwide have attempted to reproduce these results without success. Positive results have yet to be repeated or proven by the scientific community. As a result, the vast majority of the world's scientists working toward nuclear fusion dismiss excess heat production claims related to nuclear reactions in electrochemical cells.

However, the detection of charged particles, neutrons, gamma rays, and energy characteristic of fusion reactions provides an alternative method to demonstrate cold fusion (without, for example, accelerated muon particles as catalysts).

### SUMMARY OF THE INVENTION

Accordingly, the present invention is directed to a method of producing cold nuclear fusion that substantially obviates many of the problems due to the limitations and disadvantages of the related art.

Features and advantages of the invention are set forth in part in the description which follows, and in part will be apparent from the description, or may be learned by practice of the invention. The objectives and other advantages of the invention may be realized and attained by the method particularly pointed out in the written description and claims hereof as well as the appended drawings.

To achieve these and other advantages, and in accordance with the purposes of the invention, as embodied and broadly described herein, a method for producing fusion is provided. The method includes selecting a fusion-promoting material. The method may include cleaning the fusion-promoting material. Cleaning generally facilitates hydriding of the fusion-promoting material. The method may also include heat-treating the fusion-promoting material. Heat-treating should generally facilitate hydriding of the fusion-promoting material. The method further includes hydriding the fusion-promoting material with a source of isotopic hydrogen. Finally, the method includes establishing a non-equilibrium condition in the fusion-promoting material.

In another aspect of the invention, a method for preparing a fusion-promoting material for producing fusion is provided. The method includes selecting a fusion-promoting material. The method may also include cleaning the fusion-promoting material. Cleaning generally facilitates hydriding of the fusion-promoting material. Finally, the method includes hydriding the fusion-promoting material with a source of isotopic hydrogen.

It is to be understood that both the foregoing general descriptions and the following detailed descriptions are exemplary and explanatory and are intended to provide further explanation of the invention as claimed.

The accompanying drawings are included to provide a further understanding of the invention and are incorporated in, and constitute a part of, this specification. These drawings illustrate several embodiments of the invention and, together with the descriptions, serve to explain the principles of the invention.

### BRIEF DESCRIPTION OF THE DRAWINGS

The accompanying drawings, which are incorporated in, and constitute a part of, the specification, illustrate preferred embodiments of the invention. Together with the description, the drawings help to explain the objectives, advantages, and principles of the invention. In the drawings:

FIG. 1 is a front view of a foil strip according to an embodiment of the present invention;

FIG. 2 is a front view of a tie-bar according to an embodiment of the present invention;

FIG. 3 is a front view of a foil array according to an embodiment of the present invention;

FIG. 4 is a schematic representation of the foil array of FIG. 3 in a charged-particle detector;

FIG. 5 is a front view of two foil strips according to another embodiment of the present invention;

FIG. 6 is a perspective view of the two foil strips of FIG. 5 in a cylindrical assembly; and

FIG. 7 is a cut-away perspective view of the cylindrical assembly of FIG. 6 in a neutron detector.

### DETAILED DESCRIPTION OF THE PREFERRED EMBODIMENTS

Reference will now be made in detail to the present preferred embodiments of the invention, as broadly illustrated in the accompanying drawings.

### First Embodiment

To achieve these and other advantages, and in accordance with the purposes of the invention, as embodied and broadly described herein, an exemplary embodiment of the present invention is a method for producing cold nuclear fusion.

As defined herein, the term “fusion” means both nuclear reactions in which light nuclei combine to form a heavier nucleus with the release of energy and nucleon transfer reactions. Equation (1) provides an example of a nucleon transfer reaction.

d+d→p(3.02 MeV)+t(1.01 MeV) (1)

In this reaction, the reactants include two deuterons {a deuteron (“d”) includes one proton (“p”) and one neutron (“n”)}. As a result of this reaction, a neutron is transferred from one deuteron to the other, yielding one proton and one triton (a triton (“t”) includes one proton and two neutrons), but without necessarily forming an intermediate, excited, helium-4 nucleus.

As defined herein, the term “cold nuclear fusion” means fusion occurring at temperatures below those of thermonuclear processes. Typically, cold fusion reactants in an equilibrium condition have kinetic energies less than 100 eV.

The method includes selecting a fusion-promoting material. As embodied herein, a fusion-promoting material is selected. The fusion-promoting material may comprise a metal, an alloy, or a metal composition. The fusion-promoting material may also comprise other materials such as ammonium deutero-phosphate (ND₄DPO₄) or Portland cement prepared with heavy water.

As defined herein, the term “metal” means an element selected from the group consisting of lithium, sodium, potassium, rubidium, cesium, beryllium, magnesium, calcium, scandium, yttrium, titanium, zirconium, hafnium, vanadium, niobium, tantalum, chromium, molybdenum, tungsten, manganese, rhenium, iron, ruthenium, osmium, cobalt, rhodium, iridium, nickel, palladium, platinum, copper, silver, gold, zinc, cadmium, mercury, aluminum, gallium, indium, thallium, carbon, silicon, tin, lead, arsenic, antimony, bismuth, selenium, tellurium, lanthanum, cerium, praseodymium, neodymium, samarium, europium, gadolinium, terbium, dysprosium, holmium, erbium, thulium, ytterbium, lutetium, thorium, and uranium. As defined herein, the term “alloy” means a combination of multiple metals not in a fixed stoichiometric relationship. Examples include titanium 662 (titanium with about 6%-by-weight aluminum, about 6%-by-weight vanadium, and about 2%-by-weight tin) and titanium 64 (titanium with about 6%-by-weight aluminum and about 4%-by-weight vanadium). As defined herein, the term “metal composition” means a metal compound or an intermetallic compound. As defined herein, the term “metal compound” means a combination of more than one metal in a fixed stoichiometric relationship. Examples include lanthanum 3-nickel (La₃Ni), lanthanum-nickel 5 (LaNi₅), thorium-cobalt (Th₇Co₃), thorium-iron (Th₇Fe₃), thorium-manganese (Th₆Mn₂₃), thorium-nickel (Th₂Ni₁₇), and titanium-iron (TiFe). As defined herein, the term “intermetallic compound” means a combination of one or more metals with one or more nonmetals in a fixed stoichiometric relationship. Examples include barium titanate (BaTiO₃) and lithium-aluminum deuteride (LiAlD₄).

Selection of titanium as a fusion-promoting material appears to best produce fusion in this embodiment.

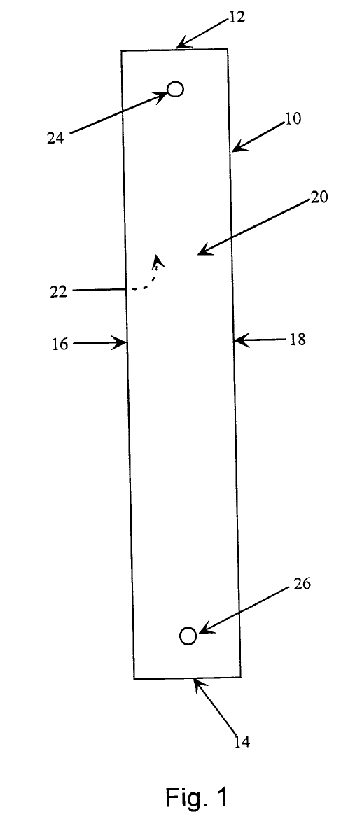

As embodied herein and referring to FIG. 1, fusion-promoting material is preferably formed into four substantially-rectangular foil strips 10. As defined herein, the term “foil strip” means a thin sheet. Each foil strip 10 has opposing ends 12 and 14, opposing sides 16 and 18, front 20, and back 22. Each foil strip 10 is preferably about 90 mm from end 12 to end 14, about 20 mm from side 16 to side 18, and about 0.025 mm to 0.25 mm thick from front 20 to back 22. Foil strips 10 should be substantially flat and possess smooth edges.

Holes 24 and 26 are punched through or otherwise formed in each foil strip 10. Holes 24 and 26 are preferably about 3 mm in diameter. The center of hole 24 is preferably located about 10 mm from end 12 and about halfway between sides 16 and 18. The center of hole 26 is preferably located about 10 mm from end 14 and about halfway between sides 16 and 18. Care should be taken to ensure that holes 24 and 26 are punched through or otherwise formed in foil strips 10 smoothly, so as to avoid rough edges.

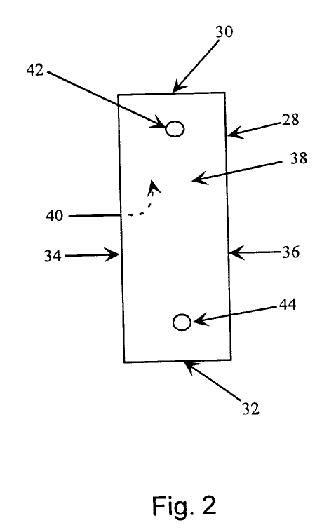

As embodied herein and referring to FIG. 2, fusion-promoting material is also preferably formed into five substantially-rectangular tie-bars 28. As defined herein, the term “tie-bar” means a thin sheet. Alternatively, tie-bars 28 may also be formed from any material that conducts electric current, such as copper. Each tie-bar 28 has opposing ends 30 and 32, opposing sides 34 and 36, front 38, and back 40. Each tie-bar 28 is preferably about 41 mm from end 30 to end 32, about 20 mm from side 34 to side 36, and about 0.025 mm to 0.25 mm thick from front 38 to back 40. Tie-bars 28 should also be substantially flat and possess smooth edges.

Holes 42 and 44 are punched through or otherwise formed in each tie-bar 28. Holes 42 and 44 are preferably about 3 mm in diameter. The center of hole 42 is preferably located about 10 mm from end 30 and about halfway between sides 34 and 36. The center of hole 44 is preferably located about 10 mm from end 32 and about halfway between sides 34 and 36. Care should be taken to ensure that holes 42 and 44 are punched through or otherwise formed in tie-bars 28 smoothly, so as to avoid rough edges.

The method may also include cleaning the fusion-promoting material. Cleaning generally facilitates hydriding of the fusion-promoting material. As embodied herein, the cleaning of the fusion-promoting material is achieved by scrubbing foil strips 10 and tie-bars 28 with a piece of abrasive wet-dry paper, sandpaper, or equivalent. The abrasive paper is preferably 100-grit aluminum oxide, waterproof abrasive paper or equivalent, commercially available from a number of sources. The fusion-promoting material is preferably wetted during scrubbing with deionized water and a detergent, and then rinsed after scrubbing with deionized water. The detergent is preferably any household liquid dishwashing detergent or equivalent, commercially available from a number of sources. Both front 20 and back 22 of foil strips 10 and front 38 and back 40 of tie-bars 28 should be repeatedly scrubbed and rinsed, until the scrubbed areas are uniform in color and, upon rinsing with deionized water, the water is seen to sheet rather than to form droplets over the scrubbed areas. Four foil strips 10 and five tie-bars 28 are then placed on cloth or paper towels or any clean, non-contaminating, absorbing material and carefully dried. During and after the cleaning of foil strips 10 and tie-bars 28, individuals handling foil strips 10 and tie-bars 28 should always wear laboratory gloves (such as PVC-type) and handle all foil strips 10 by their opposing ends 12 and 14 or opposing sides 16 and 18, and all tie-bars 28 by their opposing ends 30 and 32 or opposing sides 34 and 36, to minimize the possibility of finger-oil or other contamination.

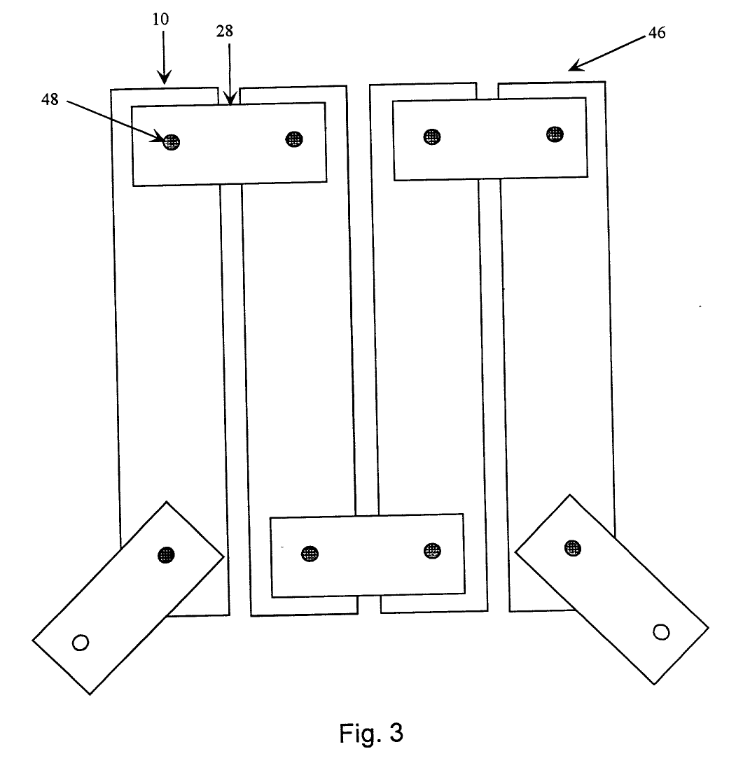

Cleaned foil strips 10 and tie-bars 28 are assembled to constitute foil array 46. As embodied herein and referring to FIG. 3, fasteners 48 connect tie-bars 28 and foil strips 10 in picket-fence-type foil array 46. To connect tie-bar 28 to foil strip 10, hole 24 or 26 of foil strip 10 is aligned with hole 42 or 44 of tie-bar 28. Fastener 48 then fastens tie-bar 28 to foil strip 10 via the aligned holes. Fasteners 48 may be any fasteners well known in the art, such as nuts and bolts, pop rivets with backing plates, spot-welding, or equivalent. As embodied herein, a path for electric current flow must exist through foil array 46. As a result, fasteners 48 preferably conduct electricity, and must conduct electric current between foil strips 10 and tie-bars 28, if foil strips 10 do not directly contact respective tie-bars 28. Foil strips 10 are spaced apart from each other and are connected only via tie-bars 28 and fasteners 48.

As embodied herein and referring to FIG. 3, three tie-bars 28 are fastened to foil strips 10 near both ends 30 and 32. Two other tie-bars 28 are fastened to foil strips 10 near only one end 30 or 32, leaving these two other tie-bars 28 with one end 30 or 32 not fastened. These two not-fastened ends 30 or 32 serve as electrical connections to foil array 46.

The method includes hydriding the fusion-promoting material with a source of isotopic hydrogen, preferably including deuterium. As defined herein, the term “isotopic hydrogen” means hydrogen or one of its isotopes: hydrogen-1, deuterium, or tritium. As defined herein, the term “hydriding” means a process by which isotopic hydrogen is loaded into or embedded within fusion-promoting material. A fusion-promoting material may not require further hydriding if it already comprises a sufficient amount of isotopic hydrogen to support fusion under non-equilibrium conditions. Importantly, tritium is radioactive, and although not discussed herein, extensive precautions, many mandated by law, must be observed when dealing with any such radioactive material.

As embodied herein, foil array 46 is turned horizontally so as to appear substantially flat when viewed from the side. A source of isotopic hydrogen in the form of a solution comprising concentrated deuterium-based acid is applied to the upper surfaces of foil strips 10 in foil array 46 using an acid brush. As defined herein, the term “deuterium-based acid” means an acid in which one or more hydrogen nuclei is replaced by one or more deuterium nuclei. Examples include variants of deuterium-sulfuric acid (D₂SO₄ or HDSO₄), deuterium-fluoric acid (DF), deuterium-nitric acid (DNO₃), and variants of deuterium-acetic acid (CD₃OD, CHD₂OD, CH₂DOD, or CH₃OD). This solution is preferably about 25%-by-volume D₂SO₄ and about 75%-by-volume heavy water. The use of laboratory gloves is important in protecting against hand injuries due to contact with acids. Additionally, typical laboratory masks should be worn for protection against acid fumes and the immediate area should be well ventilated.

After hydriding the fusion-promoting material for a minimum of about 60 minutes, excess solution is removed from the upper surfaces of foil strips 10 in foil array 46. This removal can be accomplished by daubing with a laboratory-grade, solvent-free cleaning wipe or equivalent, commercially available from a number of sources.

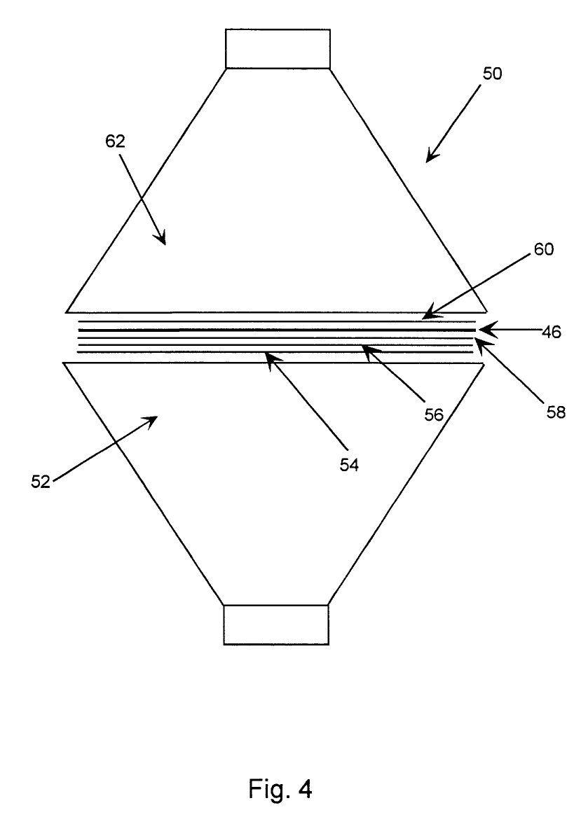

As embodied herein and referring to FIG. 4, foil array 46 is placed horizontally into charged-particle detector 50. Charged-particle detector 50 includes lower photomultiplier tube 52, glass scintillator 54, lower plastic scintillator 56, energy degrader 58, upper plastic scintillator 60, and upper photo-multiplier tube 62. Charged-particle detector 50 is preferably enclosed in a light-tight container during both measurements and control experiments. Glass scintillator 54 is glued to lower photo-multiplier tube 52 to discriminate against cosmic rays, as is known in the art. The glue is preferably optically-clear silicon glue or equivalent, commercially available from a number of sources. A vacuum is preferably applied to the glue to remove air bubbles, as is known in the art. Additionally, glass scintillator 54 is preferably glued to lower photo-multiplier tube 52 using pressure, as is known in the art. Lower plastic scintillator 56 is preferably affixed to glass scintillator 54 using optical grease or equivalent, commercially available from a number of sources, as is known in the art. Through charged-particle interactions, lower plastic scintillator 56 generates light pulses which can be detected by lower photomultiplier tube 52. Energy degrader 58 is preferably not affixed to lower plastic scintillator 56. Energy degrader 58 is preferably 1/4-mil aluminized Mylar. Upper plastic scintillator 60 is preferably affixed to upper photo-multiplier tube 62 using optical grease or equivalent, commercially available from a number of sources, as is known in the art. Through charged-particle interactions, upper plastic scintillator 60 generates light pulses which can be detected by upper photo-multiplier tube 62. Gaps between energy degrader 58, foil array 46, and upper plastic scintillator 60 should be minimized. Energy degrader 58, upper plastic scintillator 60, or both may touch foil array 46.

Charged-particle detector 50 preferably has a substantially circular sensing area with an effective diameter of at least about 125 mm. The two non-fastened tie-bar ends 30 or 32 of foil array 46 serving as electrical connections should be outside the sensing area of charged-particle detector 50.

It is important to reduce the intensity of the charged-particle background in the immediate vicinity of charged-particle detector 50. To accomplish this, bags of salt or equivalent, commercially available from a number of sources, are preferably stacked underneath the detector, as is known in the art. Additionally, boxes of borax or equivalent, commercially available from a number of sources, are preferably placed around all sides of the detector, as is also known in the art. Charged-particle detector 50 and associated electronics are then activated.

The output of charged-particle detector 50 is preferably detected, amplified, digitized, and analyzed. Detection, amplification, digitization, and analyzation are known in the art. The output of charged-particle detector 50 is preferably digitized at 100 MHz using a waveform digitizer over a 160 microsecond window. The resulting digitized data can be stored in a computer memory for subsequent analysis.

Alternatively, charged-particle detector 50 and foil array 46 can be configured using only lower photo-multiplier tube 52, glass scintillator 54, lower plastic scintillator 56, and energy degrader 58.

After reducing the intensity of the charged-particle background, control experiments are performed with charged-particle detector 50. The purpose of these control experiments is to measure, record, and compensate for the intensity of any remaining charged-particle background in the immediate vicinity of the detector. In the control experiments, H₂, H₂O, and H₂SO₄ (or a hydrogen-based acid) are substituted in place of D₂, D₂O, and D₂SO₄ (or a deuterium-based acid corresponding to the hydrogen-based acid), respectively, as the source of isotopic hydrogen for the fusion-promoting material. The recorded background is then subtracted from the actual fusion experiment measurements to provide background-corrected measurements and in the process of determining the statistical significance of output yields, as is known in the art.

The method also includes establishing a non-equilibrium condition in the fusion-promoting material. As defined herein, the term “non-equilibrium condition” means upsetting the internal steady-state condition of a fusion-promoting material before, during, or after hydriding. The non-equilibrium condition may be established by supplying energy to the fusion-promoting material. Such energy may be supplied by passing an electric current through the fusion-promoting material, or applying one or more electric or magnetic fields, electromagnetic waves, laser radiations, chemical reactions, mechanical stresses, accelerated particles, temperature changes, phase changes, or equivalent to the fusion-promoting material. As embodied herein, the non-equilibrium condition is established by passing a direct current through the fusion-promoting material. Electrical leads are connected to the non-fastened tie-bar ends of foil array 46 outside the sensing area of charged-particle detector 50. The electrical leads may be connected by any method well known in the art. As embodied herein, an approximately 3-ampere direct current is applied to foil array 46 via the electrical leads, using an appropriate electrical power source. Charged-particle detector 50 should detect charged particles above background levels due to fusion within about 12 hours, as long as charged-particle detector 50 has sufficient sensitivity. Charged-particle detector 50 should be sensitive at minimum to five charged particles per hour (source rate).

Charged-particle detector 50 and associated electronics indicate and record the number of charged particles detected per unit time. Such charged particles detected by charged-particle detector 50 can have their energies measured, and thus be identified by an appropriate detector arrangement, such as a Delta-E/Energy telescope or equivalent device, as is known in the art. Charged particles measured by the appropriate detector arrangement include protons of approximately 3 MeV from the fusion of two deuterons, yielding one proton and one triton, according to the following reaction:

d+d→p(3.02 MeV)+t(1.01 MeV) (1)

As described above, a non-equilibrium condition can be established by passing a direct current through the fusion-promoting material. More generally, the non equilibrium condition may be established by supplying energy to the fusion-promoting material. Such energy may be supplied by passing an alternating current or a combination of direct and alternating current through the fusion-promoting material, or by applying one or more electric or magnetic fields, electromagnetic waves, laser radiations, chemical reactions, mechanical stresses, accelerated particles, temperature changes, phase changes, or equivalent to the fusion-promoting material.

The method may also include selecting a form of the fusion-promoting material. As embodied herein, the form of the fusion-promoting material may comprise foil strips 10 and tie-bars 28, or arrays, balls, blocks, cells, chips, foils, lattices, matrices, membranes, meshes, sintered masses, sponges, powders, wires, or other equivalent forms. Selecting the fusion-promoting material may substantially dictate the form of the fusion-promoting material selected. Similarly, selecting the form of the fusion-promoting material may substantially dictate the fusion-promoting material selected.

The method may also include heat-treating the fusion-promoting material. Heat-treating should generally facilitate hydriding of the fusion-promoting material. As embodied herein, the fusion-promoting material may be heat-treated by heating the fusion-promoting material to a temperature near but below its melting point, maintaining that temperature for a minimum of about 30 minutes, and then cooling the fusion-promoting material to an ambient temperature over a period of no less than about 30 minutes. If the fusion-promoting material consists essentially of titanium metal, the fusion-promoting material may be heat-treated by heating it to at least approximately 750° C., maintaining a temperature of at least approximately 750° C. for a minimum of about 30 minutes, and then cooling the fusion-promoting material to an ambient temperature over a period of no less than about 30 minutes. Care should be taken not to heat the fusion-promoting material to a temperature too close to its melting point.

As embodied herein, the fusion-promoting material may be heat-treated in a vacuum of at least approximately 1×10⁻⁷ Torr. Such a combination of heat-treating and vacuum typically requires a vacuum-annealing oven. Alternatively, a vacuum chamber with electrical connections for passing an electric current through the fusion-promoting material may be used to heat-treat the fusion-promoting material. In this situation, passing the electric current through the fusion-promoting material causes heating in the fusion-promoting material. The vacuum should be maintained until the fusion-promoting material cools to an ambient temperature.

The heat-treating oven or chamber may be cleansed of metal vapors and other evolved contaminants using an inert gas. As embodied herein, argon gas may be admitted to the oven or chamber at the opposite end from which the vacuum may be drawn when the vacuum is about 2×10⁻⁵ Torr. This argon gas would generally flow toward the end from which the vacuum is being drawn, forming an “argon wind,” and helping to evacuate metal vapors and other evolved contaminants.

As embodied herein, heat-treated, fusion-promoting material should be substantially free from residual stress and have a uniformly bright finish over its entire surface.

In another aspect of the invention, a method of preparing a fusion-promoting material for producing fusion is provided. The method includes selecting a fusion promoting material. The method may include cleaning the fusion-promoting material. Cleaning generally facilitates hydriding of the fusion-promoting material. The method may also include heat-treating the fusion-promoting material. Heat-treating should generally facilitate hydriding of the fusion-promoting material. The method further includes hydriding the fusion-promoting material with a source of isotopic hydrogen. A method of preparing a fusion-promoting material for producing fusion is substantially described above.

### Second Embodiment

An alternative embodiment of the present invention also includes selecting a fusion-promoting material. As embodied herein, a fusion-promoting material is selected. As above, the fusion-promoting material may comprise a metal, an alloy, or a metal composition. The fusion-promoting material may also comprise other materials such as ammonium deutero-phosphate (ND₄DPO₄) or Portland cement prepared with heavy water.

Selection of titanium as a fusion-promoting material appears to best produce fusion in this embodiment.

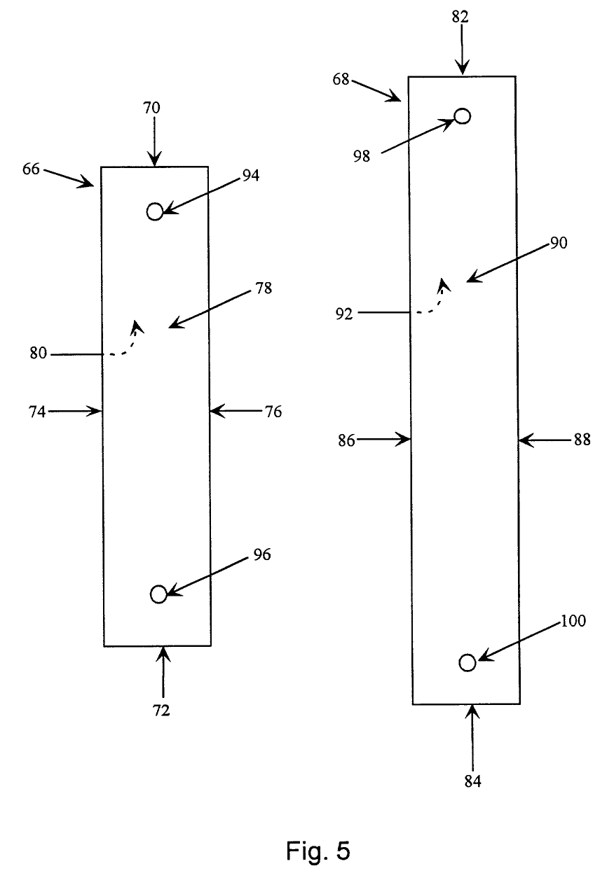

As embodied herein and referring to FIG. 5, the fusion-promoting material is preferably formed into two substantially-rectangular foil strips 66 and 68. Foil strip 66 has opposing ends 70 and 72, opposing sides 74 and 76, front 78, and back 80. Foil strip 66 is preferably about 300 mm from end 70 to end 72, about 20 mm from side 74 to side 76, and about 0.25 mm thick from front 78 to back 80. Foil strip 68 has opposing ends 82 and 84, opposing sides 86 and 88, front 90, and back 92. Foil strip 68 is preferably about 350 mm from end 82 to end 84, about 20 mm from side 86 to side 88, and about 0.25 mm thick from front 90 to back 92. Foil strips 66 and 68 should be substantially flat and possess smooth edges.

Holes 94 and 96 are punched through or otherwise formed in foil strip 66 and holes 98 and 100 are punched through or otherwise formed in foil strip 68. Holes 94, 96, 98 and 100 are preferably about 3 mm in diameter. On foil strip 66, the center of hole 94 is preferably located about 10 mm from end 70 and about halfway between sides 74 and 76. The center of hole 96 is preferably located about 10 mm from end 72 and about halfway between sides 74 and 76. On foil strip 68, the center of hole 98 is preferably located about 10 mm from end 82 and about halfway between sides 86 and 88. The center of hole 100 is preferably located about 10 mm from end 84 and about halfway between sides 86 and 88. Care should be taken to ensure that holes 94, 96, 98, and 100 are punched through or otherwise formed in foil strips 66 and 68 smoothly, so as to avoid rough edges.

The method may also include cleaning the fusion-promoting material. Cleaning generally facilitates hydriding of the fusion-promoting material. As embodied herein, the cleaning of foil strips 66 and 68 is achieved in a similar manner as cleaning the fusion-promoting material as described above.

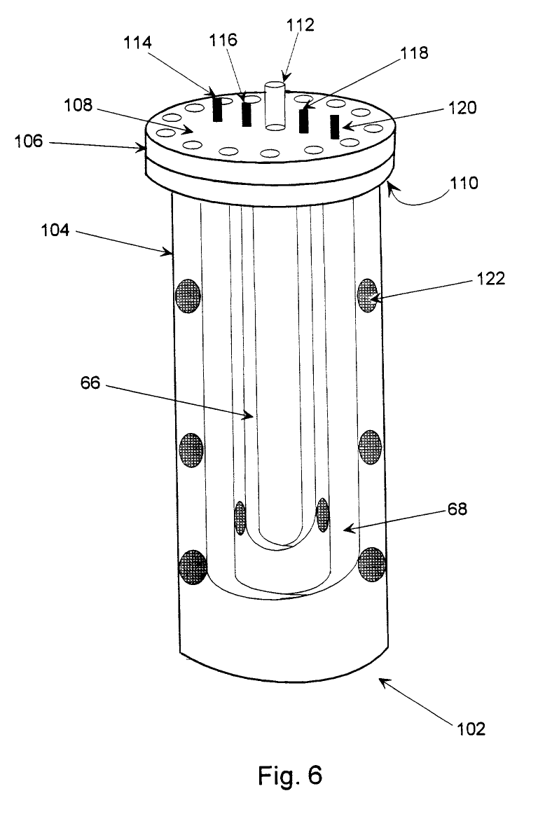

As embodied herein and referring to FIG. 6, foil strips 66 and 68 are placed inside cylindrical assembly 102. Cylindrical tube 104 is preferably about 350 mm in length and preferably about 25 mm in diameter. Cylindrical assembly 102 must be able to withstand both the vacuums and pressures specified in this embodiment. Such cylindrical assemblies 102 are known in the art.

Cylindrical assembly 102 includes cylindrical tube 104 and cap 106. Cap 106 includes top 108, bottom 110, gas access port 112, and four electrical feed-throughs 114, 116, 118, and 120. Electrical feed-throughs 116 and 118 are closer to the center of cap 106 than electrical feed-throughs 114 and 120. On foil strip 66, end 70 is attached to feed-through 116 using hole 94 and end 72 is attached to feed-through 118 using hole 96. Ends 70 and 72 attach to feed-throughs 116 and 118, respectively, at bottom 110 of cap 106. Foil strip 66 assumes a U-shaped configuration when hanging from bottom 110 of cap 106.

On foil strip 68, end 82 is attached to feed-through 114 using hole 98 and end 84 is attached to feed-through 120 using hole 100. Ends 82 and 84 attach to feed-throughs 114 and 120, respectively, at bottom 110 of cap 106. Foil strip 68 also assumes a U-shaped configuration when hanging from bottom 110 of cap 106. As a result, foil strips 66 and 68 are arranged in a concentric U-shaped configuration, with foil strip 66 inside of foil strip 68.

As embodied herein, the spacing between foil strips 66 and 68 is preferably about 3 mm, and the spacing between foil strip 68 and the interior wall of cylindrical tube 104 is preferably about 3 mm. Segments of glass wool 122, preferably Pyrex® high-temperature glass wool, commercially available from a number of sources, are used as insulation between and around foil strips 66 and 68 to prevent electrical contact between segments of foil strip 66 or 68 and other segments of foil strips 66 or 68, and between segments of foil strip 66 or 68 and cylindrical tube 104. Not all segments of glass wool 122 are shown in FIG. 6. Cap 106 is then attached to cylindrical tube 104 to form cylindrical assembly 102.

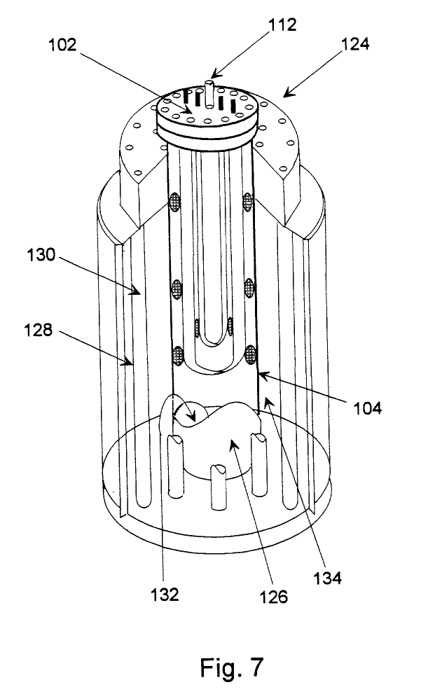

Neutrons produced by fusion may be detected by appropriate neutron detection equipment, including associated electronics. As embodied herein and referring to FIG. 7, cylindrical assembly 102 is placed inside central well 134 of neutron detector 124. Neutron detector 124 includes central well 134, plastic scintillator core 126, polyethylene moderator 128, sixteen proportional-counter tubes 130, and photo-multiplier tube 132.

The physical dimensions of cylindrical tube 104 of cylindrical assembly 102 are preferably matched to central well 134. Central well 134 preferably has a depth of about 500 mm and an inside diameter of about 48 mm.

One terminal of an approximately 20-ampere direct-current source is connected to both electrical feed-throughs 114 and 116. The other terminal is connected to both electrical feed-throughs 118 and 120.

Fill-gas for proportional-counter tubes 130 includes helium-3 gas. As embodied herein, a number of measures are preferably taken to reduce the intensity of the particle and radiation background in the immediate vicinity of neutron detector 124. These measures reduce interactions by particles and radiation not resulting from fusion in foil strips 66 and 68 with the helium-3 gas in proportional-counter tubes 130. First, neutron detector 124 is preferably housed in an underground tunnel to reduce cosmic radiation reaching proportional-counter tubes 130. Second, neutron detector 124 is preferably surrounded by plastic scintillator panels to further reduce cosmic radiation reaching proportional-counter tubes 130. Finally, neutron detector 124 is preferably further surrounded by numerous bags of salt or equivalent, commercially available from a number of sources, stacked underneath and around all sides of neutron detector 124. The bags of salt or equivalent help to reduce gamma radiation reaching proportional-counter tubes 130.

After reducing the intensity of the particle and radiation background, control experiments are performed with neutron detector 124. The purpose of these control experiments is to measure, record, and compensate for the intensity of any remaining particle and radiation background in the immediate vicinity of neutron detector 124. In the control experiments, H₂ and H₂O are substituted in place of D₂ and D₂O, respectively, as the source of isotopic hydrogen for the fusion-promoting material. The recorded background is then subtracted from the actual fusion experiment measurements to provide background-corrected measurements and in the process of determining the statistical significance of output yields, as is known in the art.

Fusion produces neutrons of high energy known as “fast neutrons.” Fast neutrons exiting cylindrical assembly 102 enter plastic scintillator core 126. Interactions of fast neutrons in plastic scintillator core 126 generate recoil protons. Recoil proton interactions in plastic scintillator core 126 generate light pulses that can be detected by photo-multiplier tube 132 located inside central well 134 at the bottom of neutron detector 124.

Interactions of fast neutrons in plastic scintillator core 126 and polyethylene moderator 128 result in the neutrons losing energy, thus becoming lower energy “thermal” neutrons. Many of these thermal neutrons enter proportional-counter tubes 130 and are captured therein by helium-3 nuclei, producing pulses in proportional-counter tubes 130. The overall efficiency of neutron detector 124 used in this embodiment in counting fast neutrons of about 2.45 MeV produced in cylindrical assembly 102 can be as high as approximately 12%. The number and physical arrangement of proportional-counter tubes 130, in combination with photo-multiplier tube 132 and specially designed electronics, discriminate against spurious signals and improve the accuracy and repeatability of measurements taken.

Further information on appropriate neutron detection equipment similar to neutron detector 124 can be found in H. O. Menlove & J. E. Swansen, A High Performance Neutron Time Correlation Counter, Nuclear Technology 71: 497-505, November 1985 and H. O. Menlove, Los Alamos National Laboratory Report LA-8939-MS (ISPO-142), August (1981).

The method includes hydriding the fusion-promoting material with a source of isotopic hydrogen, preferably including deuterium. As embodied herein, cylindrical assembly 102 is evacuated to approximately 1×10⁻² Torr via gas access port 112 while applying an approximately 12-ampere direct current to foil strips 66 and 68 via electrical feed-throughs 114, 116, 118, and 120. This first process heats foil strips 66 and 68 and induces out-gassing. After approximately sixty minutes, cylindrical assembly 102 is pressurized with gas via gas access port 112 to approximately one atmosphere for about five minutes. The gas is preferably a source of isotopic hydrogen, most preferably high purity deuterium (D₂) gas, such as research grade deuterium gas of approximately 99.8% purity, commercially available from a number of sources. Cylindrical assembly 102 is then again evacuated via gas access port 112 to approximately 1×10⁻² Torr. The approximately 12-ampere direct current remains applied throughout. This second process substantially flushes other gases from cylindrical assembly 102. After approximately sixty minutes, cylindrical assembly 102 is pressurized via gas access port 112 with a source of isotopic hydrogen, preferably high purity deuterium gas, such as research grade deuterium gas of approximately 99.8% purity, commercially available from a number of sources, to at least approximately 3 atmospheres.

The method also includes establishing a non-equilibrium condition in the fusion-promoting material. As embodied herein, an approximately 12-ampere direct current is applied in parallel to foil strips 66 and 68 via electrical feed-throughs 114, 116, 118, and 120. Neutron detector 124 should detect neutrons above background levels due to fusion within about 12 hours, as long as neutron detector 124 has sufficient sensitivity. Neutron detector 124 should be sensitive at minimum to five neutrons per hour (source rate). The fusion produces neutrons according to the following reaction:

d+d→n(2.45 MeV)+³He(0.82 MeV) (2)

Hydriding the fusion-promoting material with a source of isotopic hydrogen, preferably including deuterium, may be accomplished with a solution comprising concentrated deuterium-based acid or deuterium gas as described above, or with deuterium-based acid alone, heavy water alone, electrolytic loading (such as with an electrolyte containing D⁺ ions under the influence of an electric current), or accelerator-beam injection (such as with a beam of D⁺ ions from an accelerator).

Laboratory equipment of sufficient sensitivity should allow the detection of charged particles, neutrons, gammas, and energy according to the following initial fusion reactions:

d+d→p(3.02 MeV)+t(1.01 MeV) (3)

d+d→n(2.45 MeV)+³He(0.82 MeV) (4)

d+d→⁴He(0.08 MeV)+γ(23.77 MeV) (5)

d+⁶Li→⁴He(11.2 MeV)+⁴He(11.2 MeV) (6)

d+⁷Li→2⁴He+n+15.0 MeV (7)

and, based on proper sequencing of the above initial fusion reactions, the following subsequent fusion reactions:

p+d→³He+γ(5.4 MeV) (8)

d+t→n(11 MeV)+⁴He(3.5 MeV) (9)

d+³He→p(14.7 MeV)+⁴He(3.6 MeV) (10)

t+t→2n+⁴He+11.3 MeV (11)

t+³He→p+n+⁴He+12.1 MeV,

⁴He(4.8 MeV)+d(9.5 MeV),

⁵He(2.4 MeV)+p(11.9 MeV) (12)

p+⁶Li→⁴He(1.7 MeV)+³He(2.3 MeV) (13)

p+⁷Li→⁴He(8.65 MeV)+⁴He(8.65 MeV) (14)

p+¹¹B→3⁴He+8.7 MeV (15)

n+⁶Li→⁴He(2.1 MeV)+t(2.7 MeV) (16)

As above, the method may also include selecting a form of the fusion-promoting material. As embodied herein, the form of the fusion-promoting material may comprise foil strips 66 and 68, or arrays, balls, blocks, cells, chips, foils, lattices, matrices, membranes, meshes, sintered masses, sponges, powders, wires, or other equivalent forms. Selecting the fusion-promoting material may substantially dictate the form of the fusion-promoting material selected. Similarly, selecting the form of the fusion-promoting material may substantially dictate the fusion-promoting material selected.

The method may also include heat-treating the fusion-promoting material. Heat-treating should generally facilitate hydriding of the fusion-promoting material.

In another aspect of the invention, a method of preparing a fusion-promoting material for producing fusion is provided. The method includes selecting a fusion-promoting material. The method may also include cleaning the fusion-promoting material. Cleaning generally facilitates hydriding of the fusion-promoting material. Additionally, the method may include heat-treating the fusion-promoting material. Heat-treating should generally facilitate hydriding of the fusion-promoting material. Finally, the method also includes hydriding the fusion-promoting material with a source of isotopic hydrogen. A method of preparing a fusion-promoting material for producing fusion is substantially described above.

Fusion reactions release both charged and neutral particles among their reaction products. Some of these charged and neutral particles are released at substantial energies. Such energies can, in sufficient intensity, be extracted to run machines or to produce electricity. In addition, the energetic particles themselves can be put to use.

As a result, the methods disclosed for producing fusion and for preparing a fusion-promoting material for producing fusion provide a number of potential benefits, including, but not limited to, electrical power production, food preservation, and use in commercial heating devices and motors, generators, and engines for airborne, surface, and submerged applications. Energetic particles resulting from the fusion could also be used directly in a number of applications, such as refreshing nuclear-based devices, security and medical devices, and neutron tomography, even if net energy is consumed in the particular application.

The above description of the preferred embodiments of the invention have been presented for purposes of illustration and description. They are not intended to be exhaustive or to limit the invention to the precise form disclosed. Modifications and variations are possible in light of the above teachings, or may be acquired from practice of the invention. The embodiments were described in order to explain the principles of the invention, and their practical application was described to enable one skilled in the art to utilize the invention in various embodiments and with various modifications as are suited to the particular use contemplated. The scope of the invention is defined by the attached claims, and their equivalents.

I claim:

1. A method of producing fusion, comprising:
selecting a fusion-promoting material;
hydriding the fusion-promoting material with a source of isotopic hydrogen; and
establishing a non-equilibrium condition in the fusion-promoting material.

2. The method of claim 1, wherein the fusion-promoting material comprises titanium.

3. The method of claim 1, wherein the non-equilibrium condition is established by supplying energy to the fusion-promoting material.

4. The method of claim 1, 2, or 3, wherein the source of isotopic hydrogen comprises a deuterium-based acid, deuterium gas, or heavy water.

5. The method of claim 3, wherein the energy is supplied by passing an electric current through the fusion-promoting material, or applying one or more electric or magnetic fields, electromagnetic waves, laser radiations, chemical reactions, mechanical stresses, accelerated particles, temperature changes, or phase changes to the fusion-promoting material.

6. The method of claim 5, wherein the energy is supplied by passing a direct current through the fusion-promoting material.

7. The method of claim 6, wherein the fusion-promoting material comprises titanium.

8. The method of claim 5, wherein the energy is supplied by passing an alternating current or a combination of direct and alternating currents through the fusion-promoting material.

9. The method of claim 5, wherein a reactant in the one or more chemical reactions comprises a deuterided material.

10. The method of claim 9, wherein the fusion-promoting material comprises titanium.

11. The method of claim 9, wherein the deuterided material comprises lithium deuteride.

12. The method of claim 11, wherein the fusion-promoting material comprises titanium.

13. The method of claim 5, 6, 7, 8, 9, 10, 11, or 12, wherein the source of isotopic hydrogen comprises a deuterium-based acid, deuterium gas, or heavy water.

14. The method of claim 1, further comprising the step of selecting a form of the fusion-promoting material.

15. The method of claim 1, wherein the fusion-promoting material comprises a metal.

16. The method of claim 15, wherein the non-equilibrium condition is established by supplying energy to the fusion-promoting material.

17. The method of claim 15 or 16, wherein the source of isotopic hydrogen comprises a deuterium-based acid, deuterium gas, or heavy water.

18. The method of claim 16, wherein the energy is supplied by passing an electric current through the fusion-promoting material, or applying one or more electric or magnetic fields, electromagnetic waves, laser radiations, chemical reactions, mechanical stresses, accelerated particles, temperature changes, or phase changes to the fusion-promoting material.

19. The method of claim 18, wherein the energy is supplied by passing a direct current through the fusion-promoting material.

20. The method of claim 19, wherein the metal comprises titanium.

21. The method of claim 18, wherein the energy is supplied by passing an alternating current or a combination of direct and alternating currents through the fusion-promoting material.

22. The method of claim 18, wherein a reactant in the one or more chemical reactions comprises a deuterided material.

23. The method of claim 22, wherein the metal comprises titanium.

24. The method of claim 22, wherein the deuterided material comprises lithium deuteride.

25. The method of claim 24, wherein the metal comprises titanium.

26. The method of claim 18, 19, 21, 22, or 24, wherein the source of isotopic hydrogen comprises a deuterium-based acid, deuterium gas, or heavy water.

27. The method of claim 15, wherein the metal comprises copper, iron, lanthanum, nickel, palladium, platinum, tantalum, titanium, zinc, or zirconium.

28. The method of claim 27, wherein the metal comprises titanium.

29. The method of claim 15, further comprising the step of selecting a form of the fusion-promoting material.

30. The method of claim 1, wherein the fusion-promoting material comprises an alloy.

31. The method of claim 30, wherein the non-equilibrium condition is established by supplying energy to the fusion-promoting material.

32. The method of claim 30 or 31, wherein the source of isotopic hydrogen comprises a deuterium-based acid, deuterium gas, or heavy water.

33. The method of claim 31, wherein the energy is supplied by passing an electric current through the fusion-promoting material, or applying one or more electric or magnetic fields, electromagnetic waves, laser radiations, chemical reactions, mechanical stresses, accelerated particles, temperature changes, or phase changes to the fusion-promoting material.

34. The method of claim 33, wherein the energy is supplied by passing a direct current through the fusion-promoting material.

35. The method of claim 34, wherein the alloy comprises titanium.

36. The method of claim 33, wherein the energy is supplied by passing an alternating current or a combination of direct and alternating currents through the fusion-promoting material.

37. The method of claim 33, wherein a reactant in the one or more chemical reactions comprises a deuterided material.

38. The method of claim 37, wherein the alloy comprises titanium.

39. The method of claim 37, wherein the deuterided material comprises lithium deuteride.

40. The method of claim 39, wherein the alloy comprises titanium.

41. The method of claim 33, 34, 36, 37, or 39, wherein the source of isotopic hydrogen comprises a deuterium-based acid, deuterium gas, or heavy water.

42. The method of claim 30, wherein the alloy comprises titanium with about 6%-by-weight aluminum, about 6%-by-weight vanadium, and about 2%-by-weight tin, or titanium with about 6%-by-weight aluminum and about 4%-by-weight vanadium.

43. The method of claim 30, wherein the alloy comprises titanium.

44. The method of claim 30, further comprising the step of selecting a form of the fusion-promoting material.

45. The method of claim 1, wherein the fusion-promoting material comprises a metal composition.

46. The method of claim 45, wherein the non-equilibrium condition is established by supplying energy to the fusion-promoting material.

47. The method of claim 45 or 46, wherein the source of isotopic hydrogen comprises a deuterium-based acid, deuterium gas, or heavy water.

48. The method of claim 46, wherein the energy is supplied by passing an electric current through the fusion-promoting material, or applying one or more electric or magnetic fields, electromagnetic waves, laser radiations, chemical reactions, mechanical stresses, accelerated particles, temperature changes, or phase changes to the fusion-promoting material.

49. The method of claim 48, wherein the energy is supplied by passing a direct current through the fusion-promoting material.

50. The method of claim 49, wherein the metal composition comprises titanium.

51. The method of claim 48, wherein the energy is supplied by passing an alternating current or a combination of direct and alternating currents through the fusion-promoting material.

52. The method of claim 48, wherein a reactant in the one or more chemical reactions comprises a deuterided material.

53. The method of claim 52, wherein the metal composition comprises titanium.

54. The method of claim 52, wherein the deuterided material comprises lithium deuteride.

55. The method of claim 54, wherein the metal composition comprises titanium.

56. The method of claim 48, 49, 51, 52, or 54, wherein the source of isotopic hydrogen comprises a deuterium-based acid, deuterium gas, or heavy water.

57. The method of claim 45, wherein the metal composition comprises barium titanate, lanthanum 3-nickel, lanthanum-nickel 5, lithium-aluminum deuteride, lithium-deuteride, thorium-cobalt, thorium-iron, thorium-manganese, thorium-nickel, or titanium-iron.

58. The method of claim 45, wherein the metal composition comprises titanium.

59. The method of claim 45, further comprising the step of selecting a form of the fusion-promoting material.

60. A method of preparing a fusion-promoting material for producing fusion, comprising:
selecting the fusion-promoting material; and
hydriding the fusion-promoting material with a source of isotopic hydrogen.

61. The method of claim 60, wherein the fusion-promoting material comprises titanium.

62. The method of claim 60 or 61, wherein the source of isotopic hydrogen comprises a deuterium-based acid, deuterium gas, or heavy water.

63. The method of claim 60, further comprising the step of selecting a form of the fusion-promoting material.

64. The method of claim 60, wherein the fusion-promoting material comprises a metal.

65. The method of claim 64, wherein the metal comprises copper, iron, lanthanum, nickel, palladium, platinum, tantalum, titanium, zinc, or zirconium.

66. The method of claim 64, wherein the metal comprises titanium.

67. The method of claim 64, 65, or 66, wherein the source of isotopic hydrogen comprises a deuterium-based acid, deuterium gas, or heavy water.

68. The method of claim 64, further comprising the step of selecting a form of the fusion-promoting material.

69. The method of claim 60, wherein the fusion-promoting material comprises an alloy.

70. The method of claim 69, wherein the alloy comprises titanium with about 6%-by-weight aluminum, about 6%-by-weight vanadium, and about 2%-by-weight tin, or titanium with about 6%-by-weight aluminum and about 4%-by-weight vanadium.

71. The method of claim 69, wherein the alloy comprises titanium.

72. The method of claim 69, 70, or 71, wherein the source of isotopic hydrogen comprises a deuterium-based acid, deuterium gas, or heavy water.

73. The method of claim 69, further comprising the step of selecting a form of the fusion-promoting material.

74. The method of claim 60, wherein the fusion-promoting material comprises a metal composition.

75. The method of claim 74, wherein the metal composition comprises barium titanate, lanthanum 3-nickel, lanthanum-nickel 5, lithium-aluminum deuteride, lithium-deuteride, thorium-cobalt, thorium-iron, thorium-manganese, thorium-nickel, or titanium-iron.

76. The method of claim 74, wherein the metal composition comprises titanium.

77. The method of claim 74, 75, or 76, wherein the source of isotopic hydrogen comprises a deuterium-based acid, deuterium gas, or heavy water.

78. The method of claim 74, further comprising the step of selecting a form of the fusion-promoting material.

79. A method of producing fusion, comprising:
selecting a fusion-promoting material;
cleaning the fusion-promoting material;
hydriding the fusion-promoting material with a source of isotopic hydrogen; and
establishing a non-equilibrium condition in the fusion-promoting material.

80. The method of claim 79, wherein the fusion-promoting material comprises titanium.

81. The method of claim 79, wherein the non-equilibrium condition is established by supplying energy to the fusion-promoting material.

82. The method of claim 79, 80, or 81, wherein the source of isotopic hydrogen comprises a deuterium-based acid, deuterium gas, or heavy water.

83. The method of claim 81, wherein the energy is supplied by passing an electric current through the fusion-promoting material, or applying one or more electric or magnetic fields, electromagnetic waves, laser radiations, chemical reactions, mechanical stresses, accelerated particles, temperature changes, or phase changes to the fusion-promoting material.

84. The method of claim 83, wherein the energy is supplied by passing a direct current through the fusion-promoting material.

85. The method of claim 84, wherein the fusion-promoting material comprises titanium.

86. The method of claim 83, wherein the energy is supplied by passing an alternating current or a combination of direct and alternating currents through the fusion-promoting material.

87. The method of claim 83, wherein a reactant in the one or more chemical reactions comprises a deuterided material.

88. The method of claim 87, wherein the fusion-promoting material comprises titanium.

89. The method of claim 87, wherein the deuterided material comprises lithium deuteride.

90. The method of claim 89, wherein the fusion-promoting material comprises titanium.

91. The method of claim 83, 84, 85, 86, 87, 88, 89, or 90, wherein the source of isotopic hydrogen comprises a deuterium-based acid, deuterium gas, or heavy water.

92. The method of claim 79, further comprising the step of selecting a form of the fusion-promoting material.

93. A method of preparing a fusion-promoting material for producing fusion, comprising:
selecting the fusion-promoting material;
cleaning the fusion-promoting material; and
hydriding the fusion-promoting material with a source of isotopic hydrogen.

94. The method of claim 93, wherein the fusion-promoting material comprises titanium.

95. The method of claim 93 or 94, wherein the source of isotopic hydrogen comprises a deuterium-based acid, deuterium gas, or heavy water.

96. The method of claim 93, further comprising the step of selecting a form of the fusion-promoting material.
